(19) United States
(12) Patent Application Publication
(10) Pub. No.: US 2025/0154628 A1
(43) Pub. Date: May 15, 2025

(54) RECOVERY OF URANIUM METAL USING EUTECTIC COMPOSITIONS

(71) Applicant: Westinghouse Electric Company LLC, Cranberry Township, PA (US)

(72) Inventor: Edward J. Lahoda, Edgewood, PA (US)

(73) Assignee: Westinghouse Electric Company LLC, Cranberry Township, PA (US)

(21) Appl. No.: 18/509,127

(22) Filed: Nov. 14, 2023

(51) Int. Cl. C22B 60/02; C22B 5/02; C22B 5/04

(52) U.S. Cl. CPC C22B 60/0213; C22B 5/02; C22B 5/04

(57) ABSTRACT

A method of recovering uranium (U) metal from uranium tetrafluoride (UF₄) using a furnace including a reactor is disclosed. The method comprises placing UF₄, a first material, and a second material that is different from the first material into the reactor. A eutectic composition comprising the first material, the second material, and fluoride has a melting point that is less than the melting point of U. The method further comprises raising the initial temperature of the UF₄, the first material, and the second material to initiate a reaction between the first material, the second material, and the UF₄ which drives the temperature of the reactor to a raised temperature to form a slag phase and a metal phase separate from the slag phase in the reactor.

### FIELD

The present disclosure is generally related to nuclear fuel production, more particularly, is directed toward recovering uranium metal using eutectic compositions.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a method of recovering Uranium (U) metal from Uranium tetrafluoride (UF₄) using a furnace including a reactor is disclosed. The method comprises placing UF₄, a first material, and a second material into the reactor. The first material and the second material are different. A eutectic composition comprising the first material, the second material, and fluoride has a melting point that is less than the melting point of U. The method further comprises the step of raising the temperature of the UF₄, the first material, and the second material to an initial temperature to initiate a reaction between the first material, the second material, and the UF₄. The reaction drives the temperature of the reactor to a raised temperature resulting in the formation of a slag phase and a metal phase separate from the slag phase in the reactor, wherein the slag phase comprises the eutectic composition. The metal phase comprises U metal. The method further comprises the step of separating the metal phase from the slag phase.

In at least one aspect, at least one of the first material and the second material reacts with UF₄ to form U metal. In at least one aspect, the raised temperature is at or above the melting point of U. In at least one aspect, the method further comprises the step of cooling the furnace until the slag phase transitions into a solid slag material and the metal phase transitions into a solid metal material. In at least one aspect, the first material comprises calcium (Ca). In at least one aspect, the second material comprises magnesium (Mg). In at least one aspect, the second material comprises AlF₃. In at least one aspect, the first material comprises calcium and the second material comprises magnesium, the calcium is present at a mole fraction of about 17% based on the total amount of the first material. In at least one aspect, the first material and the second material comprise materials that do not react with U metal. In at least one aspect, the reactor comprises a graphite reactor. In at least one aspect, the graphite reactor comprises a coating of yttria (Y₂O₃).

In various aspects, a method of recovering Uranium (U) metal from a slag mixture comprising U metal and a first material using a furnace including a reactor is disclosed. The method comprises placing the slag mixture of U metal and the first material into the reactor along with a second material. The first material and the second material are different. A eutectic composition comprising the first material and the second material has a melting point that is less than the melting point of U. The method further comprises the step of raising the reactor to a temperature at or above the melting point of U to form a molten slag phase and a molten metal phase separate from the molten slag phase in the reactor. The molten slag phase comprises the eutectic composition. The molten metal phase comprises U metal. The method further comprises the step of separating the metal phase from the slag phase.

In at least one aspect, the first material comprises calcium fluoride and the second material comprises aluminum fluoride. In at least one aspect, the first material comprises magnesium fluoride and the second material comprises aluminum fluoride. In at least one aspect, the method further comprises the step of cooling the furnace until the slag phase transitions into a solid slag material and the metal phase transitions into a solid metal material. In at least one aspect, the reactor comprises a graphite reactor. In at least one aspect, the graphite reactor comprises a coating of yttria.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a schematic of a furnace 100 including a reactor for receiving a charge of materials, the furnace configured to heat the charge resulting in a chemical reaction between the materials of the charge;

FIG. 2 is a phase diagram of Calcium, Magnesium, and Fluoride;

FIG. 3 is a cross section view of a reactor with a charge of Calcium, Magnesium, and uranium tetrafluoride (UF₄) positioned in the reactor;

FIG. 4 is a cross section view of the reactor of FIG. 3 illustrating a eutectic molten slag phase positioned above a molten U metal phase after the charge reaches a temperature at or above the melting point of U; and

FIG. 5 is a cross section view of a reactor with a charge of a first material, a second material, and uranium tetrafluoride (UF₄) positioned in the reactor;

FIG. 6 is a cross section view of the reactor of FIG. 5 illustrating a eutectic molten slag phase positioned above a molten phase of U metal after the charge reaches a temperature at or above the melting point of U;

FIG. 7 is a phase diagram of Calcium, Aluminum, and Fluoride.

FIG. 8 is a cross section view of a reactor with a charge of CaF₂U and AlF₃ positioned in the reactor;

FIG. 9 is a cross section view of the reactor of FIG. 8 illustrating a eutectic molten salt slag phase positioned above a molten U metal phase after the charge reaches a temperature at or above the melting point of U;

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

Before explaining various aspects of the method for recovering uranium using eutectic compositions in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Generally, Uranium (U) metal is recovered from Uranium tetrafluoride (UF₄) using the reaction of UF₄ with either Calcium (Ca) or Magnesium (Mg) as shown in the following equations.

UF₄+2Ca→U(MP=1132° C.)+2CaF₂(MP=1418° C.)
(reaction temperature maintained above the melting point of U but below the melting point of CaF₂)

UF₄+2Mg→U(MP=1132° C.)+2MgF₂(MP=1262° C.)
(reaction maintained above the melting point of U but below the melting point of MgF₂)
   During recovery operations which utilize the above reactions, the UF₄ is initially blended with Ca metal granules or Mg metal granules in a blender to create a charge that is loaded into a reactor which is then placed into a retort furnace. The retort furnace is then heated to a desired temperature to heat the charge within the reactor which results in the above chemical reactions to separate the U metal from the salt slag mixture (i.e., either CaF₂ or MgF₂). The furnace can then be cooled and the U metal can be separated from the salt slag mixture. The above reactions and preparation of the charge and retort furnace are described in a Nuclear Engineering and Technology (NET) Journal article to S. Gupta et al. entitled “Effect of oxygen containing compounds in uranium tetrafluoride on its non-adiabatic calciothermic reduction characteristics”, published 2021. The disclosure of S. Gupta et al. entitled “Effect of oxygen containing compounds in uranium tetrafluoride on its non-adiabatic calciothermic reduction characteristics” is incorporated by reference herein in its entirety.

With regard to the above reactions, in one aspect, the furnace is heated above the melting point of U but below that of CaF₂ or MgF₂, respectively, to separate the U metal from UF₄. In such instances, due to the density of Uranium, the molten U metal will move toward the bottom of the furnace and leave the solid salt slag phase (i.e., either CaF₂ or MgF₂) floating on top of the U metal. The furnace can then be cooled and the solid salt slag can be separated from the solid U metal. However, with this process, not all of the U metal will separate from the CaF₂ or MgF₂ solid phase floating at the top of the furnace. In other words, some of the U metal becomes trapped within the solid phase CaF₂ or MgF₂. In this or similar existing uranium recovery processes, usually >90% of the U metal is recovered in a molten pool with either the lighter solid MgF₂ or CaF₂ floating on top. While not a significant economic loss for low or non-enriched U, this can be a significant economic penalty for higher enriched uranium production. Further, the CaF₂ and MgF₂ wastes are also now contaminated with U metal which can slowly oxidize to form hydrogen if moisture is present. Since these uranium contaminated wastes are disposed of as low-level waste, they are normally transported and disposed of in metal drums. In such instances, the hydrogen can cause these drums to rupture, and fires and explosions have been known to occur in the areas where this waste is disposed of. Methods have been tried to recover the uranium metal from the waste products which range from milling and gravity separation to dissolution of the uranium with carbonate chelates followed by recovery using ion exchange. These approaches however are expensive, time consuming, and usually at least some amount of uranium is left behind in the waste solids.

As noted in the disclosure of S. Gupta et al. entitled “Effect of oxygen containing compounds in uranium tetrafluoride on its non-adiabatic calciothermic reduction characteristics”, a graphite reactor may be utilized to recover U metal from UF₄ and the reactor of the conversion furnace can be lined with a Y₂O₃ suspension (i.e., Yttria) applied as a paint to protect the reactor from potential corrosion. In previous technologies ground CaF₂ or MgF₂ slag was used as a furnace liner which formed an inexpensive but porous protection barrier for the furnace refractories. In instances where MgF₂ or CaF₂ slags are used as the furnace liner, the amount of U metal trapped in the slag is increased. However, coating the lining of a graphite style reactor with Yttria can prevent, or at least substantially reduce, the breakdown of the lining of the furnace due to the reaction with the corrosive salt mixtures such as MgF₂ or CaF₂ salt during U recovery operations. This is at least in part due to Y₂O₃ having a melting point of (2,425° C.) which is well above the melting point of the salt slags and Uranium. In various aspects, lining the reactors of a conversion furnace with Yttria permits the consideration of fluid slags which can be formed by forming or mixing various fluoride compounds to yield low melting slag eutectics, as discussed in greater detail below.

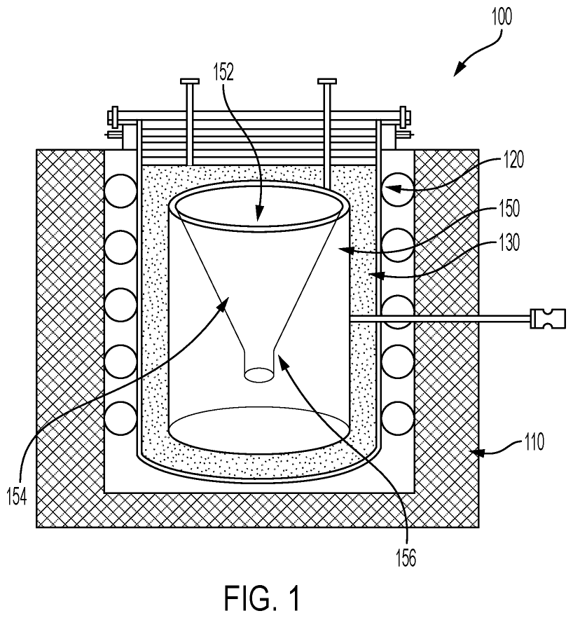

Turning now to FIG. 1, a refractory, or furnace 100, comprising a furnace lining 110, a heating element 120, a retort 130, and a reactor 150 is illustrated. In at least one aspect, the reactor 150 comprises graphite. In any event, the reactor 150 comprises a charge portion 152 that includes a conical funnel opening 154 which terminates in a bottom opening 156. The charge portion 152 of the reactor 150 is configured to receive a charge (e.g., a mixture of materials) therein. In at least one aspect, the charge portion 152 of the reactor 150 is lined with a coating, or paint, of Yttria. In use, a mixture of materials is placed in the charge portion 152 of the reactor 150 and then heated to cause a reaction which, in various aspects, forms a slag portion in the conical funnel opening 154 and a metal portion in the bottom opening 156.

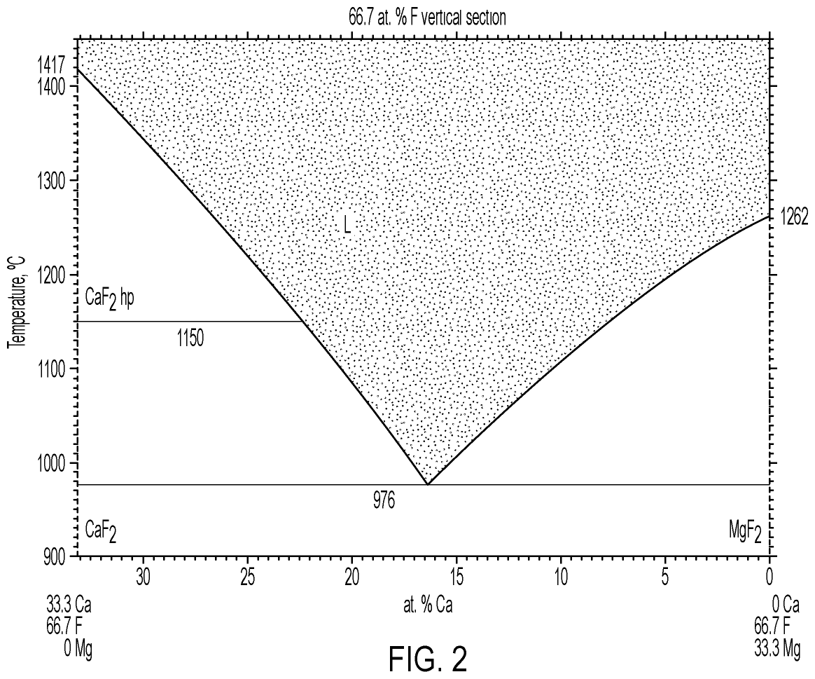

As will be described in further detail below, a furnace such as the furnace 100 can be utilized to separate U metal from UF₄ by forming a eutectic composition during the reaction that will melt at a lower temperature than the U metal to recover the U metal from UF₄. In at least one aspect, a ˜17 atomic % of Ca in Mg metal is used for the charge to reduce the UF₄ to U metal which yields a slag melting temperature of 976° C. (see FIG. 2 which is a phase diagram of “Ca—Mg—F”). In at least one aspect, the slag melting temperature is below the melting point of the U metal and, thus, the slag will form a separate molten phase floating on top of a molten phase of U metal when the sustained reaction raises the temperature of the charge above the melting point of the U metal, as discussed in greater detail below.

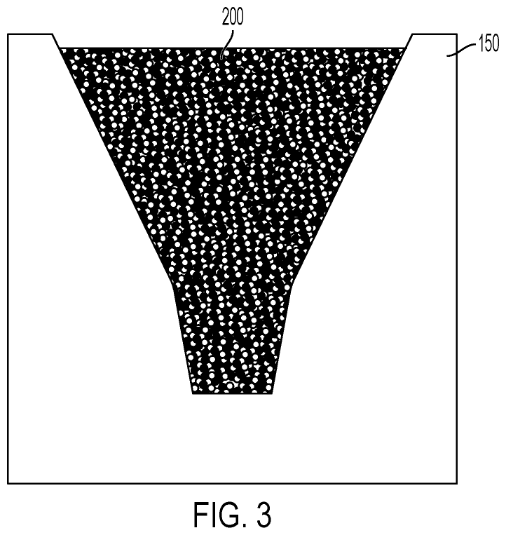

The below equation is an example of using Ca and Mg to form a lower melting eutectic with Fluoride (F) to recover U metal from UF₄. In at least one aspect, the UF₄ material is mixed with Ca material and Mg material to create a charge 200 which is then placed into a reactor, such as the reactor 150, as shown in FIG. 3. The mixture (i.e., charge 200) is then heated to an initial temperature to initiate the reaction between the Ca, the Mg, and the UF₄ to form a slag phase and a metal phase separate from the slag phase in the reactor 150. The initial temperature is selected based on the size of the furnace, the size of the chemical reactor, and/or based on the properties of the materials within the charge 200. In any event, the initial temperature is selected such that a chemical reaction will begin between the Ca, the Mg, and the UF₄ when the charge 200 is heated to the initial temperature.

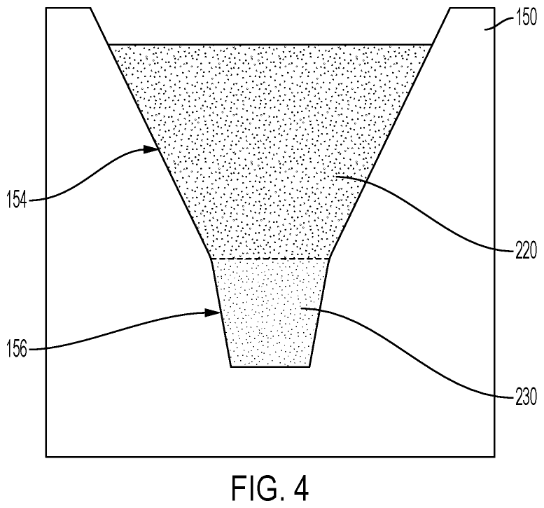

Further to the above, in at least one aspect, the slag phase comprises the eutectic composition of CaMgF₄, which has a lower melting point than U, and the metal phase comprises U metal. Initially, the charge 200 is heated by the reactor 150 to the initial temperature to initiate a chemical reaction between the Ca, the Mg, and the UF₄. Once the chemical reaction begins, the heat of the reaction between the Ca and Mg and the UF₄ will drive the temperature of the reactor 150 to a raised temperature that is at or above the melting point of U (i.e., also above the melting point of the lower-melting eutectic composition of CaMgF₄) resulting in a molten slag phase 220 of CaMgF₄ floating on top of a molten metal phase 230 of U metal, as illustrated in FIG. 4. During the reaction, the more dense molten U metal will separate from the lower-melting eutectic composition of CaMgF₄ by moving toward the bottom of the reactor 150 as the less dense molten CaMgF₄ is pushed toward the top of the reactor 150. In at least one aspect, the molten metal phase 230 will move to the bottom of the reactor 150 and collect in the bottom opening 156 while the molten slag phase 220 will move toward the top of the reactor 150 and collect in the conical funnel opening 154. Once the molten slag phase 220 of CaMgF₄ and the molten metal phase of U metal are separated, the furnace 100 is cooled until the molten slag phase 220 of CaMgF₄ transitions into solid slag CaMgF₄ and the molten metal phase of U metal transitions into solid U metal. Once cooled, the solid U metal can be separated from the solid slag CaMgF₄.

UF₄+Ca+Mg→U(MP 1132° C.)+CaMgF₄(MP 976° C.)
(reactor temperature greater than or equal to 1132° C.)

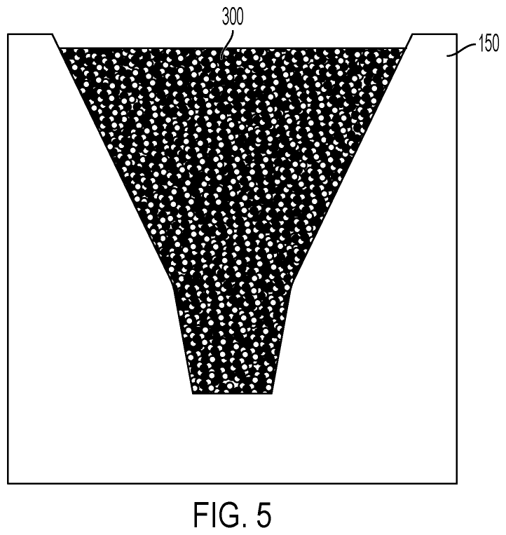

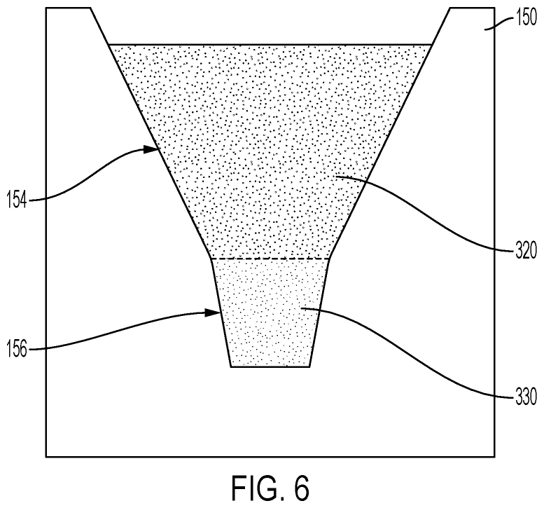

Further to the above, recovering U metal from UF₄ may be utilized with different combinations of materials to form a lower melting eutectic composition. The below equation is representative of a first material X and a second material Z which can be initially mixed with UF₄ as a charge 300 and placed in a reactor, such as the reactor 150, as illustrated in FIG. 5. The charge 300 is then heated in the reactor to an initial temperature to initiate a chemical reaction between the first material X, the second material Z, and the UF₄. Once the chemical reaction begins, the heat of the reaction will drive the reactor temperature to a raised temperature at or above the melting point of U resulting in a molten slag phase 320 of XZF_{q} floating on top of a molten metal phase 330 of U metal, as illustrated in FIG. 6. Once separated, the furnace can be cooled until the molten slag phase of XZF_{q} transitions into a solid slag of XZF_{q} and the molten metal phase 330 of U metal transitions into solid U metal. Once cooled, the solid U metal can be separated from the solid slag of XZF_{q}.

UF₄+X+Z→U(MP 1132° C.)+XZF_{q}
(reactor temperature above the melting point of XZF_{q} and greater than or equal to the melting point of U)

Further to the above, in at least one aspect, the first material X and the second material Z are different. In at least one aspect, the first material X and the second material Z must form a lower melting fluoride compound eutectic. In at least one aspect, the eutectic composition of the first material X, the second material Z in the fluoride form will melt at a lower temperature than U metal. In at least one aspect, the first material X and the second material Z must not be reactive with Uranium. In at least one aspect, the residual solubility of the eutectic forming materials have a low solubility in U metal. In at least one aspect, the “q” in F_{q} is the fluoride form resulting from the chemical reaction between the first material X, the second material Z, and the UF₄.

Further to the above, in at least one aspect X is calcium and Z is magnesium in the above equation. In at least one instance Z is magnesium and X is calcium in the above equation. In at least one instance, X can be AlF₃ and Z can be Ca in the above equation. In at least one aspect, X can be AlF₃ and Z can be Mg in the above equation. In at least one aspect, X can be AlF₃ and Z can be a mixture of Ca and Mg in the above equation. In at least one aspect, X can be any compound that forms a eutectic below the melting point of U when mixed with either CaF₂ or MgF₂ and does not react with U metal and/or is not soluble in U metal in the above equation.

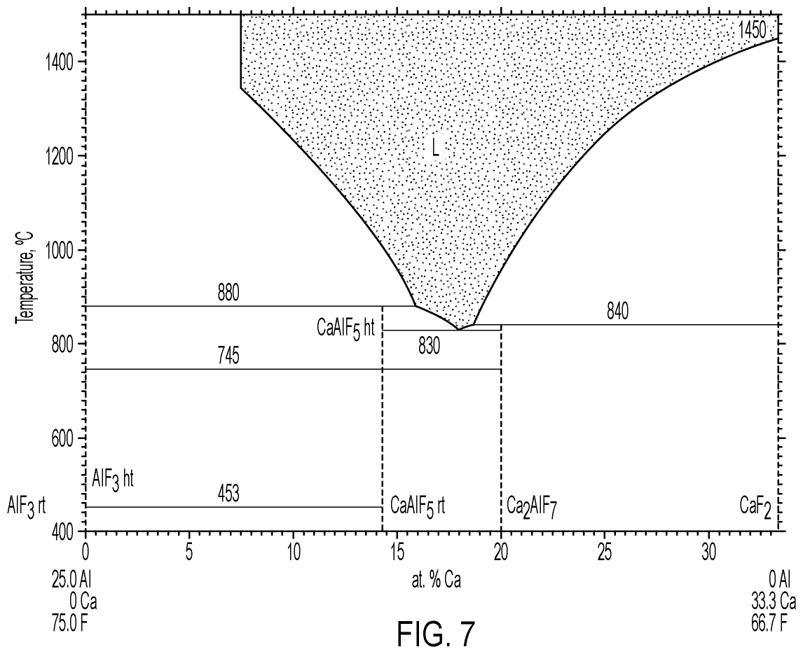

As discussed above, current/previous Uranium metal recovery methods resulted in some amount of U metal trapped within a salt slag mixture of either CaF₂ or MgF₂ after U metal recovery operations. In such instances, initially mixing the slag mixture of either CaF₂U or MgF₂U into the reactor with an addition material that can form a eutectic composition with CaF₂ or MgF₂ which has a lower melting point than U can extract the remaining U metal from the slag mixture by raising the temperature of the mixture above the melting point of U. In at least one aspect the U metal is recovered by first using Ca to reduce the UF₄ to U metal, as discussed above, followed by treatment of the CaF₂ slag by grinding the slag and mixing with, for example, AlF₃ with ˜18 mole % of CaF₂ based on total moles of (CaF₂+AlF₃) which yields a slag melting point of 830° C. (see FIG. 7 “Ca—Al—F”). U metal recovery operations of this nature are described in greater detail below.

The below equation represents a method of U metal recovery where the additional material mixed with the salt slag mixture is AlF₃ which can form a eutectic composition with CaF₂. As such, the below equation is representative of a reaction for forming a eutectic composition of CaAlF₅ to extract the trapped U metal from the salt slag mixture of CaF₂U.

CaF₂U+AlF₃→U(MP 1132° C.)+CaAlF₅(MP 830° C.)
(reactor temperature at or above 1132° C.).

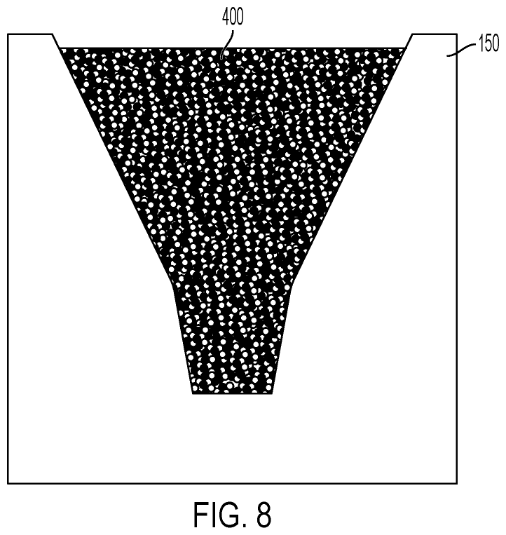

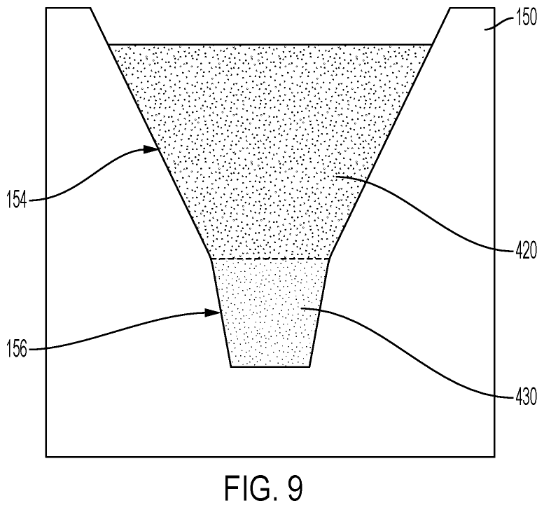

Further to the above, in at least one aspect, the salt slag CaF₂ comprising some amount of U metal is mixed with AlF₃ as a charge 400 and placed into a reactor, such as the reactor 150, as illustrated in FIG. 8. The charge 400 is heated to a temperature which is at or above the melting point of U. The heat from the furnace raises the temperature of the reactor to a raised temperature that is at or above the melting point of U resulting in a molten slag phase 420 of CaAlF floating on top of a molten metal phase 430 of U metal, as illustrated in FIG. 9. Once separated, the furnace can be cooled until the molten slag phase 420 of CaAlF₅ transitions into solid slag CaAlF₅ and the molten metal phase 430 of U metal transitions into solid U metal. Once cooled, the solid U metal can be separated from the solid slag of CaAlF₅.

As discussed above, the use of low melting eutectic forming mixtures to form two immiscible molten phases with one phase being U metal and the other being a fluoride salt is utilized to provide better recovery of U metal from UF₄ compared to previous/existing methods. In at least one aspect, a mixture of 8 mole % to 23 mole % Ca in Mg to reduce UF₄ to U metal is utilized. In at least one aspect, a mixture of from 12 mole % to 23 mole % Ca in AlF₃ to form a low melting eutectic to recover U metal from CaF₂ is utilized. Further, in at least one aspect, a mixture of from 8 mole % to 23 mole % CaF₂ in MgF₂ to form a low melting eutectic to recover U metal from CaF₂ or MgF₂ is utilized.

Various aspects of the present disclosure include, but are not limited to, the aspects listed in the following numbered clauses.

Clause 1-In various aspects, a method of recovering Uranium (U) metal from Uranium tetrafluoride (UF₄) using a furnace including a reactor. The method comprises placing UF₄, a first material, and a second material into the reactor. The first material and the second material are different. A eutectic composition comprising the first material, the second material, and fluoride has a melting point that is less than the melting point of U. The method further comprises raising the temperature of the UF₄, the first material, and the second material to an initial temperature to initiate a reaction between the first material, the second material, and the UF₄. The reaction drives the temperature of the reactor to a raised temperature resulting in the formation of a slag phase and a metal phase separate from the slag phase in the reactor. The slag phase comprises the eutectic composition. The metal phase comprises U metal. The method further comprises the step of separating the metal phase from the slag phase.

Clause 2—The method of Clause 1, wherein at least one of the first material and the second material reacts with UF₄ to form U metal.

Clause 3—The method of Clauses 1 or 2, wherein the raised temperature is at or above the melting point of U.

Clause 4—The method of Clauses 1, 2, or 3, further comprising the step of cooling the furnace until the slag phase transitions into a solid slag material and the metal phase transitions into a solid metal material.

Clause 5—The method of Clauses 1, 2, 3, or 4, wherein the first material comprises calcium (Ca).

Clause 6—The method of Clauses 1, 2, 3, 4, or 5, wherein the second material comprises magnesium (Mg).

Clause 7—The method of Clauses 1, 2, 3, 4, or 5, wherein the second material comprises AlF₃.

Clause 8—The method of Clauses 1, 2, 3, or 4, wherein the first material comprises calcium and the second material comprises magnesium, wherein the calcium is present at a mole fraction of about 17% based on the total amount of the first material.

Clause 9—The method of Clauses 1, 2, 3, 4, 5, 6, 7, or 8, wherein the first material and the second material comprise materials that do not react with U metal.

Clause 10—The method of Clauses 1, 2, 3, 4, 5, 6, 7, 8, or 9, wherein the reactor comprises a graphite reactor.

Clause 11—The method of Clause 10, wherein the graphite reactor comprises a coating of yttria.

Clause 12-In various aspects, a method of recovering Uranium (U) metal from a slag mixture comprising U metal and a first material using a furnace including a reactor is disclosed. The method comprises placing the slag mixture of U metal and the first material into the reactor along with a second material. The first material and the second material are different. A eutectic composition comprising the first material and the second material has a melting point that is less than the melting point of U. The method further comprises the step of raising the reactor to a temperature at or above the melting point of U to form a molten slag phase and a molten metal phase separate from the molten slag phase in the reactor. The molten slag phase comprises the eutectic composition. The molten metal phase comprises U metal. The method further comprises the step of separating the metal phase from the slag phase.

Clause 13—The method of Clause 12, wherein the first material comprises calcium fluoride and the second material comprises aluminum fluoride.

Clause 14—The method of Clause 12, wherein the first material comprises magnesium fluoride and the second material comprises aluminum fluoride.

Clause 15—The method of Clauses 12, 13, or 14, further comprising the step of cooling the furnace until the slag phase transitions into a solid slag material and the metal phase transitions into a solid metal material.

Clause 16—The method of Clauses 12, 13, 14, or 15, wherein the reactor comprises a graphite reactor.

Clause 17—The method of Clause 16, wherein the graphite reactor comprises a coating of yttria.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A method of recovering Uranium (U) metal from Uranium tetrafluoride (UF₄) using a furnace including a reactor, wherein the method comprises:
placing UF₄, a first material, and a second material into the reactor, wherein the first material and the second material are different, and wherein a eutectic composition comprising the first material, the second material, and fluoride has a melting point that is less than the melting point of U;
raising the temperature of the UF₄, the first material, and the second material to an initial temperature to initiate a reaction between the first material, the second material, and the UF₄, wherein the reaction drives the temperature of the reactor to a raised temperature resulting in the formation of a slag phase and a metal phase separate from the slag phase in the reactor, wherein the slag phase comprises the eutectic composition, and wherein the metal phase comprises U metal; and
separating the metal phase from the slag phase.

2. The method of claim 1, wherein at least one of the first material and the second material reacts with UF₄ to form U metal.

3. The method of claim 1, wherein the raised temperature is at or above the melting point of U.

4. The method of claim 1, further comprising the step of cooling the furnace until the slag phase transitions into a solid slag material and the metal phase transitions into a solid metal material.

5. The method of claim 1, wherein the first material comprises calcium (Ca).

6. The method of claim 1, wherein the second material comprises magnesium (Mg).

7. The method of claim 1, wherein the second material comprises AlF₃.

8. The method of claim 1, wherein the first material comprises calcium and the second material comprises magnesium, wherein the calcium is present at a mole fraction of about 17% based on the total amount of the first material.

9. The method of claim 1, wherein the first material and the second material comprise materials that do not react with U metal.

10. The method of claim 1, wherein the reactor comprises a graphite reactor.

11. The method of claim 10, wherein the graphite reactor comprises a coating of yttria.

12. A method of recovering Uranium (U) metal from a slag mixture comprising U metal and a first material using a furnace including a reactor, wherein the method comprises:
placing the slag mixture of U metal and the first material into the reactor along with a second material, wherein the first material and the second material are different, and wherein a eutectic composition comprising the first material and the second material has a melting point that is less than the melting point of U;
raising the reactor to a temperature at or above the melting point of U to form a molten slag phase and a molten metal phase separate from the molten slag phase in the reactor, wherein the molten slag phase comprises the eutectic composition, and wherein the molten metal phase comprises U metal; and
separating the metal phase from the slag phase.

13. The method of claim 12, wherein the first material comprises calcium fluoride and the second material comprises aluminum fluoride.

14. The method of claim 12, wherein the first material comprises magnesium fluoride and the second material comprises aluminum fluoride.

15. The method of claim 12, further comprising the step of cooling the furnace until the slag phase transitions into a solid slag material and the metal phase transitions into a solid metal material.

16. The method of claim 12, wherein the reactor comprises a graphite reactor.

17. The method of claim 16, wherein the graphite reactor comprises a coating of yttria.
